(19) United States
(12) Patent Application Publication
(10) Pub. No.: US 2013/0156918 A1
(43) Pub. Date: Jun. 20, 2013

(54) DEVICE FOR ALLOWING SIMULTANEOUS CONSUMPTION OF A FROZEN CONFECTION AND A BEVERAGE

(71) Applicants: Ernest R. Reinhardt, Dana Point, CA (US); Tracy Reinhardt, Newport Beach, CA (US)

(72) Inventors: Ernest R. Reinhardt, Dana Point, CA (US); Tracy Reinhardt, Newport Beach, CA (US)

(21) Appl. No.: 13/325,763

(22) Filed: Dec. 14, 2011

(51) Int. Cl. B29C 39/10; A23G 9/48; A23P 1/10

(52) U.S. Cl. 426/515; 249/63

(57) ABSTRACT

Provided is a device that include a first mold member and a second mold member detachably engageable with the first mold member. The first mold member includes an internal reservoir for storing and dispensing a beverage. The first and second mold members collectively define a mold cavity for forming a freezable confection. The device is further configured such that a user may simultaneously consume the frozen confection and the beverage.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a device for forming a frozen confection, and more specifically, to a device which allows for simultaneous consumption of the frozen confection along with a quantity of liquid, such as an alcoholic beverage.

Frozen confections, such as Popsicles®, are widely recognized as a favorite refreshment during the warm summertime months for individuals of all ages. Recent advancements have occurred in the frozen confection industry which have resulted in several products that are multi-colored, multi-flavored, multi-textured, low fat, and low calorie. In addition to frozen confections, adults of legal drinking age also enjoy frozen cocktails as summertime refreshments. Exemplary frozen cocktails include frozen margaritas, strawberry daiquiris and other slush-style alcoholic beverages.

In addition to such frozen cocktails, it is well known to include alcohol in gelatin type foods. For instance., one type of product mixes vodka, or other alcoholic beverages, with a prepared gelatin before the gelatin solidifies or hardens. The gelatin is then chilled and hardens with the alcoholic beverage contained therein. Although these alcoholic gelatin products provide an alternative to alcoholic beverages, they are not frozen, and therefore, may not be as refreshing as a completely frozen refreshment.

Completely freezing alcoholic beverages to enjoy in frozen form has proven to be problematic due to the low freezing point of alcohol. For instance, water freezes at 32° F. under normal conditions, while alcohol generally freezes at −179° F. under normal conditions. Alcoholic beverages will typically freeze at a temperature between the freezing temperatures of water and alcohol, depending on the percentage of alcohol in the beverage. Therefore, it becomes difficult to freeze frozen alcoholic confections having high alcoholic content. As such, frozen confections, such as Popsicles® generally do not include any alcoholic content due to the complexity associated with freezing alcohol.

In view of the foregoing, there is a need in the art for a device which allows a frozen confection to be served with an alcoholic beverage to allow for simultaneous consumption of the frozen confection and the alcoholic beverage. The present invention addresses this particular need, as will be discussed in more detail below.

### BRIEF SUMMARY

There is provided a device that includes a mold cavity for forming a frozen confection, and an internal reservoir for storing a beverage, preferably, an alcoholic beverage. The device is further configured such that a user may simultaneously consume the frozen confection and the beverage. Along these lines, the internal reservoir may be pre-filled at a manufacturing/bottling facility and sold at room temperature for extended shelf life. The device may then be frozen by the consumer prior to use.

According to one embodiment, the device comprises a first mold member including a handle portion, a flange portion connected to the handle portion, and a shaft extending from the flange portion and terminating to define a distal end portion. The shaft further defines a shaft opening at the distal end portion. The first mold member includes a reservoir in communication with the shaft opening for receiving and storing a beverage. The device additionally includes a second mold member connectable to the first mold member to collective define the mold cavity for molding the freezable confection.

The device may additionally include a cap or seal engaged with the first mold member and the second mold member to contain the freezeabe confection within the mold cavity and the beverage within the internal reservoir. The cap or seal may be a foil-type seal which is secured to the first and second mold members by an adhesive. Alternatively, the cap or seal may include a snap-on cap that snaps to the first mold member and the second mold member.

In use, the first and second mold members are connected to define the mold cavity. A freezeable confection is poured into the mold cavity and a beverage is poured into the internal reservoir. The device is then placed in a freezer to freeze the freezable confection and to chill the beverage. The device is then removed from the freezer for consumption of the confection and the beverage. If the device includes a seal or cap, the seal or cap is removed, and then the second mold member is disengaged from the first mold member to expose the frozen confection. The device is configured such that the frozen confection and the beverage may be simultaneously consumed by a user.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a device for molding and serving a first frozen substance and a second liquid substance;

FIG. 2 is an upper perspective view of the device in claim 1, wherein the device includes a second mold member removed from a first mold member;

FIG. 3 is a side sectional view of the device with a first substance in a melted state and a liquid disposed within an internal reservoir;

FIG. 4 is a side sectional view of the device shown in FIG. 3, with the first substance in a frozen state;

FIG. 5 is an exploded upper perspective view of the device;

FIG. 6 is an exploded view of a second embodiment of the device including a reusable cap; and

FIG. 7 is a side sectional view of the device depicted in FIG. 6.

### DETAILED DESCRIPTION

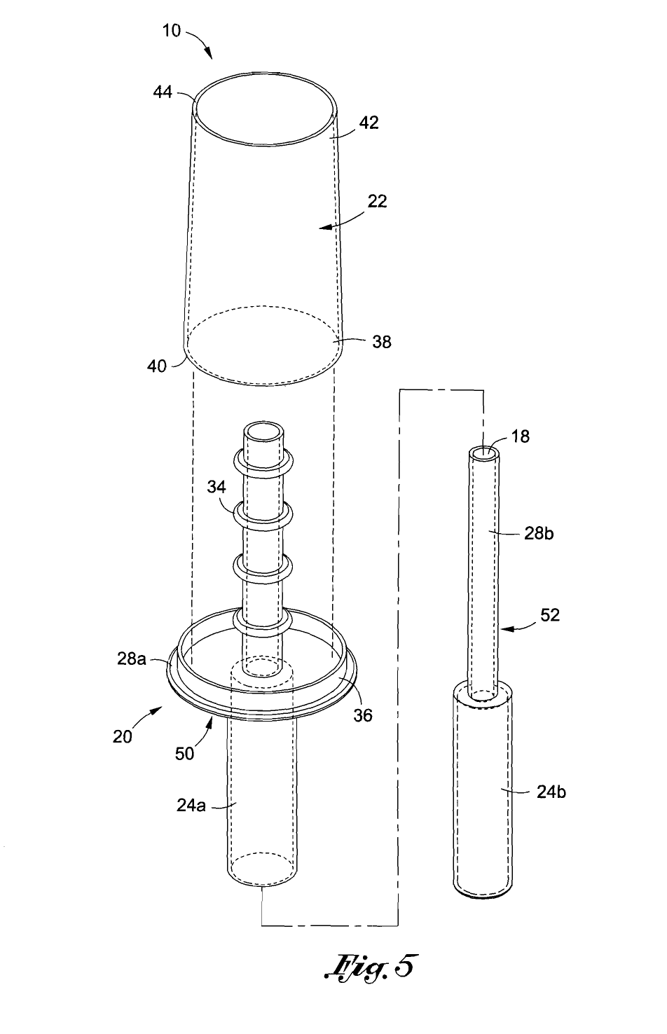

Referring now to the drawings wherein the showings are for purposes of illustrating a preferred embodiment of the present invention, and not for purposes of limiting the same, there is provided a device 10 for preparing, storing and serving a chilled item having an outer portion comprised of freezable confection 12 (see FIG. 3) and an inner portion comprised of a beverage 14 (see FIG. 3), preferably an alcoholic beverage. In this regard, the device 10 is specifically configured to allow an individual to simultaneously consume a frozen confection 12 and an alcoholic beverage 14. More specifically, the device 10 includes a mold cavity 16 for receiving and storing the freezable confection 12, and an internal reservoir 18 (see FIGS. 3 and 4) for receiving and storing the alcoholic beverage 14. The mold cavity 16 and internal reservoir 18 are configured to allow the frozen confection 12 and the alcoholic beverage 14 to be consumable at the same time. For instance, in the embodiment shown in the Figures, the mold cavity 16 is coaxially disposed about the internal reservoir 18 such that when the user consumes the outer frozen confection 12, the user may also consume the beverage 14 from the internal reservoir 18.

It is contemplated that the internal reservoir 18 may be pre-filled with an alcoholic beverage 14 and the mold cavity 16 may be pre-filled with a freezable confection at a manufacturing facility. The device 10 may be transported and stocked at room temperature for extended shelf life. After the device 10 is purchased by the consumer, the device 10 may be chilled prior to consumption to freeze the confection and the chill the alcoholic beverage.

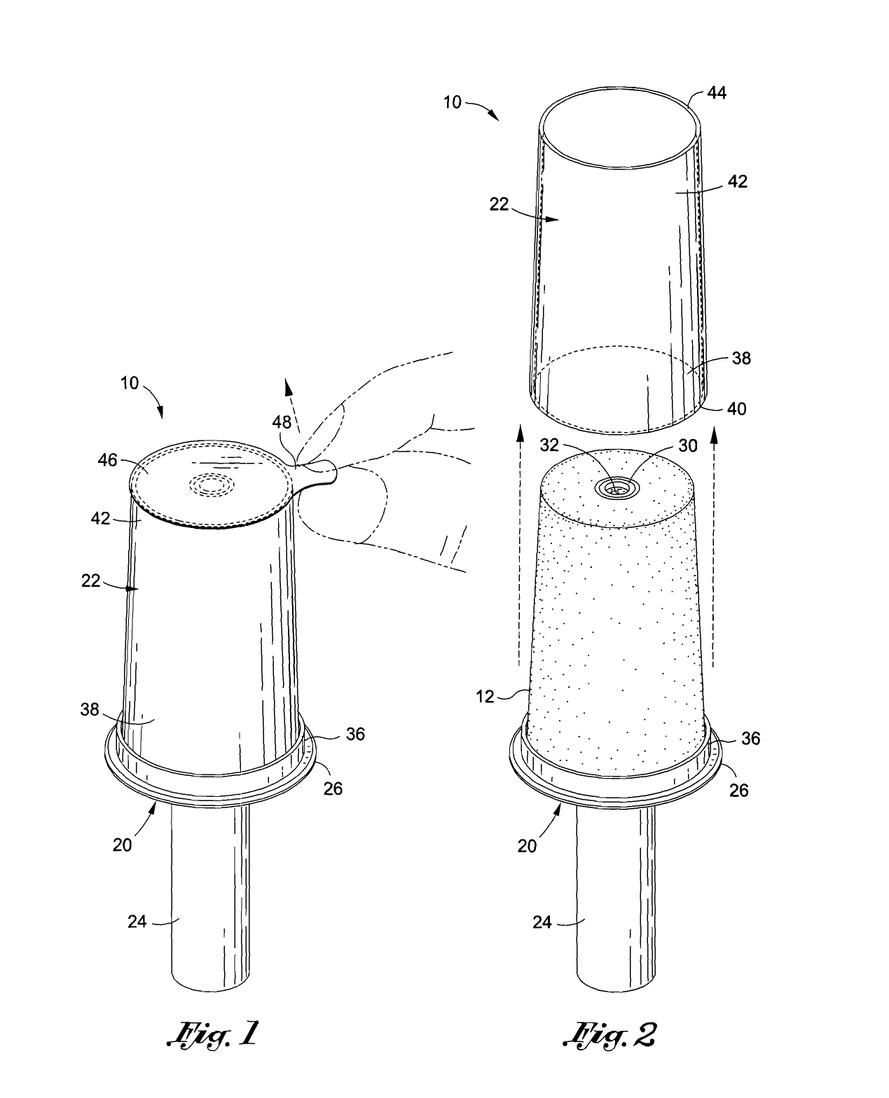

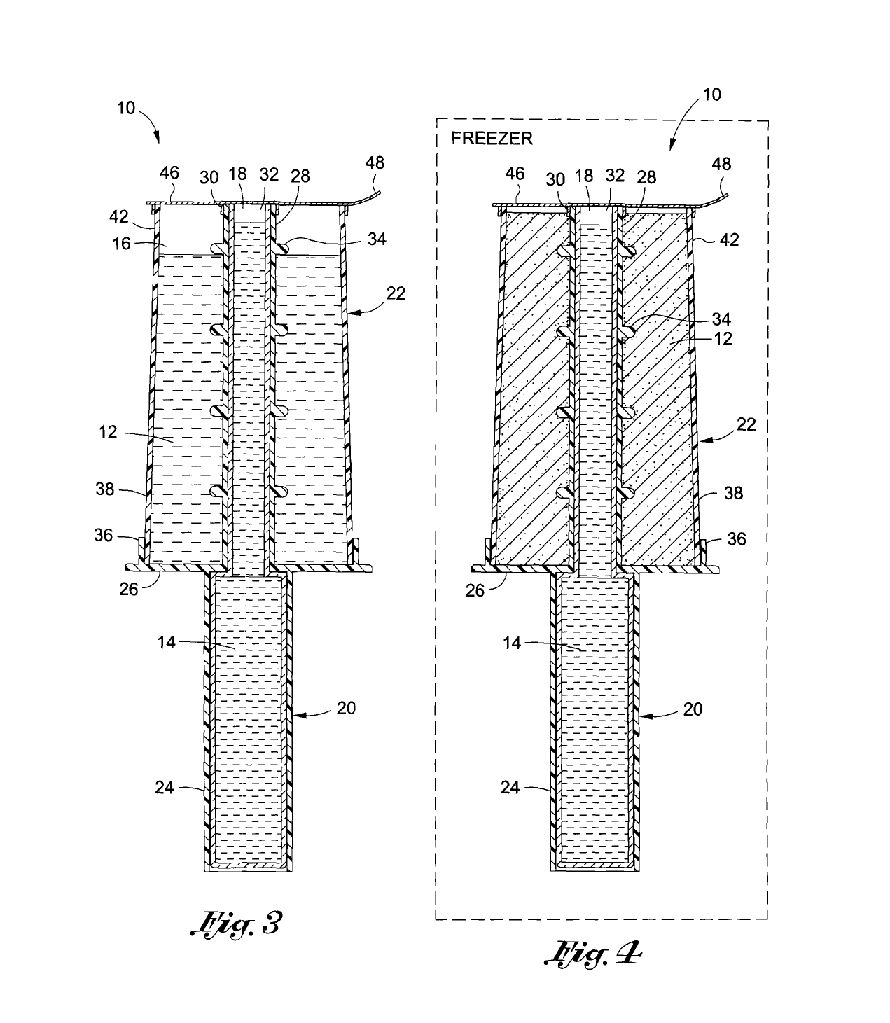

The device 10 includes a first mold member 20 and a second mold member 22. FIG. 1 shows the first and second mold members 20, 22 in an assembled configuration, and FIG. 2 shows the first and second mold members 20, 22 in an exploded or disassembled configuration. As will be described in more detail below, the first and second mold members 20, 22 are disposed in the assembled configuration to collectively form the mold cavity 16 within which the freezable confection 12 may be poured, stored and frozen. When the user desires to consume the frozen confection 12 and the beverage 14, the second mold member 22 is removed from the first mold member 20, as shown in FIG. 2 to expose the frozen confection 12 and to obtain access to the beverage 14.

The first mold member 20 includes a handle portion 24 (see FIGS. 1 and 2), a flange portion 26 (see FIGS. 1 and 2) connected to the handle portion 24, and a shaft 28 (see FIGS. 3 and 4) extending from the flange portion 26 to define a distal end portion 30 (see FIGS. 2-4). In the embodiment depicted in the drawings, the handle portion 24 and the shaft 28 each define a generally cylindrical shape, with the outer diameter of the handle portion 24 being slightly larger than the outer diameter of the shaft 28. The handle portion 24 is specifically configured to facilitate clutching or gripping of the device 10 by the user. As such, the handle 24 may extend from the flange portion 26 to define a length that is suitable to enable a user to grip or clutch the device 10 via the handle portion 24. The cylindrical shape of the handle portion 24 and shaft 28 are exemplary in nature only, and those skilled in the art will appreciate that other configurations may be used without departing from the spirit and scope of the present invention. For instance, the handle portion 24 may define an ergonomic configuration with indents or grooves which are complimentary to a user's hand.

The shaft 28 defines a shaft opening 32 (see FIGS. 2-4) at the distal end portion 30 thereof, with the internal reservoir 18 being in communication with the shaft opening 32 for receiving and storing the alcoholic beverage 14. The internal reservoir 18 may extend completely through the shaft 28, and at least partially into the handle portion 24, as is shown in FIGS. 3 and 4. The size or volume defined by the internal reservoir 18 correlates to the amount of beverage 14 capable of being dispensed by the device 10. Preferably, the internal reservoir 18 defines a volume of at least 0.5 to 2.0 ounces; however, it is contemplated that the internal reservoir 18 may define a volume that is larger or smaller than 1.5 oz. The shaft 28 additionally defines a shaft length that is equal to the distance from the flange portion 26 to the distal tip of the shaft 28.

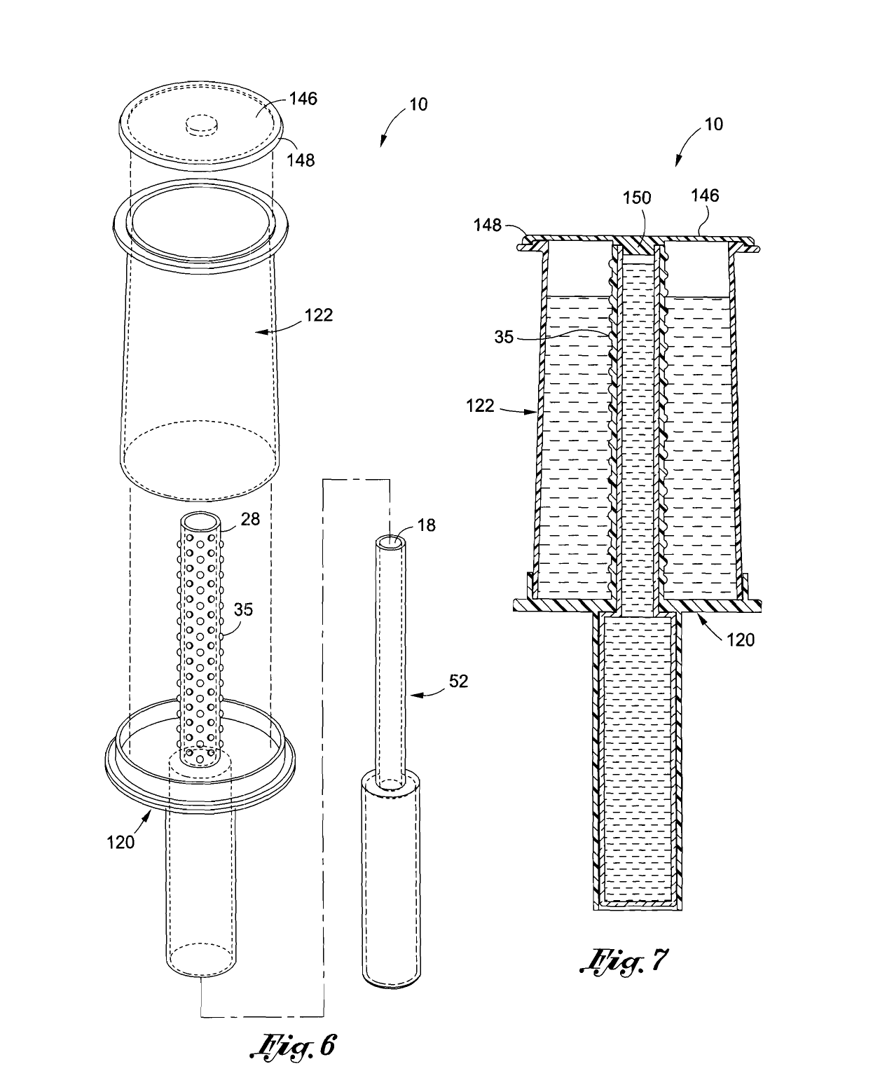

According to one aspect of the present invention, the outer surface of the shaft 28 may define an irregular, or roughened surface for mitigating inadvertent sliding of the frozen confection 12 from the first mold member 20. FIGS. 3-5 show a shaft 28 having series of rings 34 disposed in spaced relation to each other along the length of the shaft 28. The rings 34 extend radially outwardly into the frozen confection 12 to mitigate inadvertent sliding of the confection 12 along the shaft 28. Although rings 34 are shown in FIGS. 3-5, it is contemplated that the outer surface of the shaft 28 may be roughened to mitigate sliding of the confection 12 along the shaft 28. FIGS. 6-7 show another embodiment of the shaft 28 having a plurality of nodules 35 disposed on the outer surface of the shaft 28 to mitigate inadvertent sliding of the confection 12 along the shaft 28. The nodules 35 shown in FIGS. 6-7 are semi-spherical and are evenly spaced along the shaft 28, although those skilled in the art will appreciate that the nodules 35 may define other shapes, and may be irregularly spaced along the shaft 28.

The flange portion 26 of the first mold member 20 resides between the handle portion 24 and the shaft 28. In other words, the shaft 28 extends from the flange portion 26 in a first direction and the handle portion 24 extends from the flange portion 26 in an opposing second direction. The flange portion 26 defines a circular disc shape having an outer diameter that is larger than the handle portion 24 or the shaft 28. A cylindrical ring 36 (see FIGS. 1-4) extends from the flange portion 26 in the same direction as the shaft 28, with the cylindrical ring 34 circumnavigating the shaft 28. The cylindrical ring 34 is configured to engage with the second mold member 22, as described in more detail below.

The second mold member 22 includes a first end portion 38 defining a first edge 40 (see FIG. 2) and a opposing second end portion 42 defining a second edge 44 (see FIG. 2). The second mold member 22 is hollow to define an opening extending axially along the second mold member 22 between the first end portion 38 and the second end portion 42. In the embodiment depicted in the Figures, the second mold member 22 defines a tubular cross section in a direction perpendicular to its longitudinal axis, wherein the second mold member 22 is tapered such that the diameter adjacent the first end portion 38 is larger than the diameter adjacent the second end portion 42. However, those skilled in the art will appreciate that the second mold member 22 may define a cross-section that is uniform along its length (i.e., not tapered), or other shapes (i.e., quadrangular, triangular, etc.) without departing from the spirit and scope of the present invention. The second mold member 22 defines a second mold member length from the first edge 40 to the second edge 44, wherein the second mold member length is substantially equal to the shaft length to enable the mold cavity 16 and the internal reservoir 18 to be capped by a single cover, as shown in FIGS. 1, 3, and 4, and as discussed in more detail below.

The second mold member 22 is connectable to the first mold member 20 to collectively define the mold cavity 16. More specifically, the mold cavity 16 is defined by the inner wall of the second mold member 22, the outer wall of the shaft 28 and the top surface of the flange portion 26. A first substance, such as a freezable confection 12, is poured or otherwise disposed within the mold cavity 16 to mold the first substance therein.

The first and second mold members 20, 22 may include structural features to facilitate engagement between the first mold member 20 and the second mold member 22. In the embodiment depicted in the Figures, the second mold member 22 engages with the cylindrical ring 36 and the flange portion 26 when the second mold member 22 is coupled to the first mold member 20. Along these lines, the first end portion 38 of the second mold member 22 and the cylindrical ring 36 of the first mold member 20 may be configured to cooperatively engage via press-fit/frictional engagement to secure the second mold member 22 to the first mold member 20. The engagement is secure enough to contain the freezable confection 12 within the mold cavity 16 when the confection 12 is in its liquid form.

Although the foregoing describes a cylindrical ring 36 to facilitate engagement between the first and second mold members 20, 22, it is contemplated that other engagement techniques may also be employed. For instance, the flange portion 26 may define a groove within which the first end portion 38 of the second mold member 22 may be inserted into to engage the first mold member 20 to the second mold member 22.

The first and second mold members 20, 22 are preferably formed of a material that is configured to withstand freezing temperatures needed to freeze the freezable confection 12. Furthermore, the first and second mold members 20, 22 are configured to withstand any expansion or contraction of the confection 12 as it is frozen. Along these lines, it may be preferable to not completely fill the mold cavity 16 with the freezeable confection 12 to allow for expansion of the confection 12 during the freezing process. FIG. 3 shows the freezable confection 12 disposed within the mold cavity 16 with a sufficient amount of space to allow the confection 12 to expand when frozen, as shown in FIG. 4.

Referring now to FIGS. 1, 3, and 4, the device 10 further includes a seal or cap 46 extending over the shaft opening 32 of the first mold member 20 and the second end portion 42 of the second mold member 22 to form a fluid tight seal between the cap 46 and the first mold member 20 and the second mold member 22. The seal 46 preferably includes a tab 48 to allow a user to easily grip the seal 48 to remove it from the first and second mold members 20, 22, as depicted in FIG. 1.

The seal 46 may be a foil-type seal, which may be pulled or torn from the first and second mold members 20, 22. An adhesive may be used to secure the foil-type seal 46 to the first and second mold members 20, 22. In this regard, a foil-type seal 46 is configured for a single use, i.e., once it is removed, it cannot be reattached to the first and second mold members 20, 22.

As an alternative, and referring now to FIGS. 6 and 7, there is shown a second embodiment of the device 10 including a snap-fit cap 146 which frictionally engages with the first mold member 120 and the second mold member 122. More specifically, such a snap fit cap 146 would include an outer engagement portion 148 configured to engage with the second mold member 122 to create a fluid tight seal therebetween, and an inner engagement portion 150 configured to engage with the first mold member 120 to create a fluid tight seal therebetween. The snap-fit cap 146 may advantageously allow for multiple uses thereof, such that the first mold member 120, second mold member 122 and cap 146 may be reused on multiple occasions.

In one preferred embodiment of the present invention, the first mold member 20 is formed from a unitary body. Along these lines, the handle portion 24, flange portion 26 and shaft 28 comprise a single unit. Referring now to FIG. 5, other embodiments may include a first mold member 20 formed from a plurality of elements. More specifically, the first mold member 20 includes an outer body 50 and an inner body 52 that is configured to be removably insertable within the outer body 50 to define a nested configuration. In this regard, the outer body 50 includes an inner wall defining an inner cavity sized to receive the inner body 52. Furthermore, the inner body 52 may define an outer wall that is complimentary in shape to the inner wall of the outer body 50 to enable insertion and nesting of the inner body 52 within the outer body 50. The detachable configuration of the outer and inner bodies 50, 52 may advantageously allow for refilling of the internal reservoir 18 with the beverage 14 during use of the device 10. In other words, the inner body 52 may be removed from the outer body 50 to refill the reservoir 18 at a location spaced from the outer body 50 to mitigate inadvertent spilling of the beverage 14 onto the confection 12 during the refilling process.

As shown in FIG. 5, the outer body 50 defines the handle portion 24a, flange portion 26a and the outer surface of the shaft 28a. Accordingly, the outer body 50 and the second mold member 22 collectively define the mold cavity 16. The inner body 52 includes an inner shaft portion 28b and an inner handle portion 24b, with the inner shaft portion 28b residing inside of the outer shaft portion 28a and the inner handle portion 24b residing inside of the outer handle portion 24a when the inner body 52 is inserted within the outer body 50. The inner body 52 further defines the reservoir 18 within which the alcoholic beverage is stored.

The inner body 52 and outer body 50 may be configured to facilitate engagement between the inner and outer bodies 52, 50 upon insertion of the inner body 52 into the outer body 50. In other words, the inner and outer bodies 52, 50 may be configured to maintain the inner body 52 within the outer body 50 when the inner body 52 is inserted therein. Along these lines, inner and outer bodies 52, 50 may be configured to facilitate snap-fit engagement upon insertion of the inner body 52 into the outer body 50. Furthermore, an adhesive or other mechanical fastener known in the art may be used to maintain the inner body 52 within the outer body 50.

When the inner body 52 is nested within the outer body 50, the distal end of the inner body 52 is preferably flush with the distal end of the outer body 50. Furthermore, the outer wall of the inner shaft portion 28b is substantially in contact with the inner wall of the outer shaft portion 28a.

Referring now back to FIGS. 1-4, usage of the device 10 entails coupling the first mold member 20 to the second mold member 22 to define the mold cavity 16. The freezeable confection 12 is disposed within the mold cavity 16 through the opening at the second end portion 42 of the second mold member 22. It is contemplated that the freezable confection 12 may include fruit juices, or other freezable confections known in the art. Furthermore, although the majority of the beverage 14 is disposed within the reservoir 18, a small amount of the beverage 14 may also be mixed with the freezable confection 12, so long as the beverage does not prevent the confection 12 from freezing (i.e., a small amount of an alcoholic beverage may not prevent the confection 12 from freezing). The beverage 14 is also disposed within the internal reservoir 18 through the shaft opening 32. The beverage 14 may include vodka, rum, tequila, other alcoholic beverages, as well as non-alcoholic beverages. The mold cavity 16 and internal reservoir 18 are enclosed with the cap or seal 46. The device 10 is then placed within a freezer to freeze the confection 12 and chill the beverage 14.

To consume the confection 12 and the beverage 14, the device 10 is removed from the freezer and the cap/seal 46 is removed from the first and second mold members 20, 22. The second mold member 22 is then removed from engagement with the first mold member 20 to expose the frozen confection 12. To consume the beverage 14, the user may tilt the device 10 to pour the beverage 14 from the internal reservoir 18 into the user's mouth while the user chews the frozen confection 12. As such, the device 10 allows the user to simultaneously enjoy the frozen confection 12 and the beverage 14.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for molding a first substance and storing a second substance, the device comprising:
a first mold member including:
a handle portion;
a flange portion connected to the handle portion; and
a shaft extending from the flange portion and terminating to define a distal end portion, the shaft defining a shaft opening at the distal end portion;
the first mold member defining a reservoir in communication with the shaft opening for receiving and storing the second substance; and
a second mold member being connectable to the first mold member to collectively define a mold cavity for molding the first substance.

2. The device as recited in claim 1, wherein the shaft extends into the mold cavity.

3. The device as recited in claim 1, wherein the shaft is concentrically disposed relative to the second mold member when the second mold member is connected to the first mold member.

4. The device as recited in claim 1, wherein the flange portion includes a plate member extending radially outward from the handle portion to define a radial edge, and a peripheral wall extending from the plate member adjacent the radial edge.

5. The device as recited in claim 4, wherein the second mold member defines a shape that is complimentary to the peripheral wall to cooperatively engage the peripheral wall when the second mold member is connected to the first mold member.

6. The device as recited in claim 1, wherein the second mold member defines a first end portion, an opposing second end portion, and an opening extending axially along the second mold member between the first end portion and the second end portion.

7. The device as recited in claim 6, further comprising a seal connectable to the second end portion of the second mold member and the distal end portion of the shaft to cover the opening of the second mold member and the shaft opening.

8. The device as recited in claim 1, wherein the reservoir defines a volume of approximately 1 ounce.

9. The device as recited in claim 1, wherein the first mold member includes an outer body and an inner body, the inner body being configured to be inserted into the outer body to define a nested configuration.

10. The device as recited in claim 9, wherein the outer body defines the flange portion and further includes an outer shaft portion, and an outer handle portion disposed on opposed sides of the flange portion.

11. The device as recited in claim 10, wherein the outer body includes an internal wall extending from the outer shaft portion to the outer handle portion to define a central cavity.

12. The device as recited in claim 11, wherein the inner body defines an inner shaft portion and an inner handle portion, the inner body defining a shape that is complimentary to the internal wall to allow the inner body to be nested within the central cavity.

13. A device for molding a first substance and storing a second substance, the device comprising:
a first mold member including a hollow shaft defining a shaft opening and a reservoir in communication with the shaft opening for receiving and storing the second substance; and
a second mold member being connectable to the first mold member to collectively define a mold cavity for molding the first substance.

14. The device as recited in claim 13, wherein the shaft extends into the mold cavity.

15. The device as recited in claim 13, wherein the shaft is concentrically disposed relative to the second mold member when the second mold member is connected to the first mold member.

16. The device as recited in claim 1, wherein the second mold member defines a first end portion, an opposing second end portion, and an opening extending axially along the second mold member between the first end portion and the second end portion.

17. The device as recited in claim 16, further comprising a seal connectable to the second end portion of the second mold member and the shaft to cover the opening of the second mold member and the shaft opening.

18. The device as recited in claim 13, wherein the reservoir defines a volume of approximately 1 ounce.

19. The device as recited in claim 13. wherein the first mold member includes an outer body and an inner body, the inner body being configured to be inserted into the outer body to define a nested configuration.

20. A method of forming a food item having a molded portion comprised of a first substance and a liquid portion comprised of a second substance, the method comprising the steps of:
a) providing a device including mold cavity and a reservoir;
b) filling the mold cavity with the first substance;
c) filling the reservoir with the liquid portion; and
d) sealing the mold cavity and the reservoir.
